(19) United States
(12) Patent Application Publication
(10) Pub. No.: US 2025/0294214 A1
(43) Pub. Date: Sep. 18, 2025

(54) SYSTEM AND METHOD FOR RANKING RECOMMENDATIONS IN STREAMING PLATFORMS

(71) Applicant: JIO PLATFORMS LIMITED, Ahmedabad (IN)

(72) Inventors: Nikhil Kumar SINGH, Singrauli (IN); Bhupendra SINHA, Pune (IN); Gaurav DUGGAL, Hyderabad (IN); Venkateshwaran M, Chennai (IN); Manoj Kumar GARG, Morena (IN)

(73) Assignee: JIO PLATFORMS LIMITED, Ahmedabad (IN)

(21) Appl. No.: 18/861,661

(22) PCT Filed: Apr. 29, 2023
(86) PCT No.: PCT/IB2023/054492

§ 371 Date: Oct. 30, 2024

(30) Foreign Application Priority Data
Apr. 30, 2022 (IN) 202221025403

(51) Int. Cl. H04N 21/466; H04N 21/25; H04N 21/442; H04N 21/45

(52) U.S. Cl. CPC H04N 21/4668; H04N 21/251; H04N 21/44222; H04N 21/4532; H04N 21/4666

(57) ABSTRACT

The present disclosure provides a system and method for ranking recommendations in a streaming platform. The system uses temporal information in calculations of Bayesian Personalized Rankings (BPR) to consider a sequence of user interactions. The system incorporates indexing user-items prior to the BPR calculations for faster training. The indices generated through the BPR technique are used as inputs to a long short-term memory (LSTM) optimization model which help in better convergence to an optimization function. Further, the system uses a content-based filtering technique and a collaborative filtering technique for processing user items during various modes of user interactions. Hence, the system provides an improved and meaningful ranking of recommendations to users on streaming platforms.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for recommending content to users in a streaming platform. More particularly, the present disclosure relates to a system and a method for ranking recommendations in the streaming platform.

### BACKGROUND OF INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Streaming platforms include subscribed viewers and an increase in the number of user interactions. Hence, it becomes increasingly challenging to process vast information associated with the streaming platforms. Further, recommending personalized content to the users becomes a complex process while ensuring viewer experience and retention.

Conventional systems recommend content based on a user watch history and other interactions that lack ranking. Further, there is always a time constraint to update recommendations based on a recent watch history of the user within the same session. Conventional systems do not provide a balance between exploring new content/genres and are based strictly based on a user profile. Conventional systems do not address cold start problems and lack a direct relation between user interest and recommending content.

US20130103634A1 describes a recommendation system that offers item recommendations to users based on one or more items known to be liked by the users. However, the recommendation system does not generate a sparse interaction data.

US20090132519A1 describes a method of ranking a plurality pieces of media content, where each of the plurality pieces of media content has at least one relationship with at least one of a plurality of users. However, the method does not address cold start problems.

U.S. Pat. No. 7,624,095B2 describes systems and methods for fast collaborative filtering through sketch function-based approximations. However, the systems and methods do not consider temporal information while generating recommendations.

CN105488216B describes a recommender system and method based on an implicit feedback collaborative filtering algorithm. However, the recommender system and method does not consider online recommendations based on a watch history/user interaction.

CN106021329A describes a user similarity-based sparse data collaborative filtering recommendation method. However, the filtering method does not consider online recommendations based on a watch history/user interaction.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that indexes user item interactions prior to a Bayesian Personalized Ranking (BPR), and therefore, greatly reduces time complexity and speeds up training time.

It is an object of the present disclosure to provide a system and a method that incorporates temporal information while calculating the BPR, and thereby, improves relative rankings of recommendations.

It is an object of the present disclosure to provide a system and a method that uses indices generated from the BPR, instead of user items as inputs to long short-term memory (LSTM) optimization model, thereby providing better convergence to an optimization function.

It is an object of the present disclosure to provide a system and a method that recommends personalized content to users while ensuring viewer experience and retention.

It is an object of the present disclosure to provide a system and a method that uses a cosine similarity technique between an inference output of a trained optimization model and a user interaction, thereby generating significant results compared to conventional systems.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for generating personalized recommendations based on user preferences. The system may include a processor and a memory operatively coupled to the processor that stores instructions to be executed by the processor. The processor may receive a user parameter from one or more users via a computing device. The one or more users may operate the computing device and may be connected to the processor via a network. The user parameter may be based on a user watch history and a user interaction data with a time sequence. The processor may generate a user data matrix with the time sequence based on the user watch history and the user interaction data. The processor may index the generated user data matrix and rank, via a primary technique, the user data matrix based on the user watch history and the user interaction data. The processor may predict, via an artificial intelligence (AI) engine, a time-wise user preference in an offline mode based on the ranking of the user data matrix and a new content suggestion. The processor may generate an optimized model based on the time-wise user preference. The processor may recommend a time-wise user sequence in an online mode based on the generated optimized model and a subscribed user activity.

In an embodiment, the processor may index the generated user data matrix using an approximate nearest neighbors oh yeah (Annoy) technique.

In an embodiment, the primary technique may include a Bayesian personalized ranking (BPR) technique.

In an embodiment, the new content suggestion may be based at least on an age group, a region, and a country associated with the one or more users.

In an embodiment, the processor may predict the time-wise user preference and generate the optimized model using an LSTM technique.

In an embodiment, the processor may recommend the time-wise user sequence using a cosine similarity technique.

In an embodiment, the subscribed user activity may include one or more user session data in the online mode.

In an embodiment, the processor may generate the optimized model by being configured to generate a sparse implicit interaction dataset based on the user interaction data and the user watch history.

In an embodiment, the processor may generate the optimized model by being configured to generate, via the primary technique, an initial distribution of data based on the sparse implicit interaction dataset, index the initial distribution of data to generate one or more indices and scale the one or more indices, reiterate the primary technique on the scaled one or more indices, and generate the optimized model.

In an embodiment, the scaled one or more indices may include temporal information associated with the user watch history, the user interaction data, and the subscribed user activity.

In an embodiment, the processor may generate the user data matrix using at least one of a content-based filtering technique and a collaborative filtering technique.

In an aspect, the present disclosure relates to a method for generating personalized recommendations based on user preferences. The method may include receiving, by a processor associated with a system, a user parameter from one or more users. The user parameter may be based on a user watch history and a user interaction data with a time sequence. The method may include generating, by the processor, a user data matrix with the time sequence based on the user watch history and the user interaction data. The method may include indexing, by the processor, the generated user data matrix and ranking, via a primary technique, the user data matrix based on the user watch history and the user interaction data. The method may include predicting, by the processor, via an AI engine, a time-wise user preference in an offline mode based on the ranking of the user data matrix and a new content suggestion. The method may include generating, by the processor, an optimized model based on the time-wise user preference. The method may include recommending, by the processor, a time-wise user sequence in an online mode based on the generated optimized model and a subscribed user activity.

In an embodiment, the method may include indexing, by the processor, the generated user data matrix using an Annoy technique.

In an embodiment, the primary technique may include a BPR technique.

In an embodiment, the method may include predicting, by the processor, the time wise user preference and generating the optimized model using an LSTM technique.

In an embodiment, the method may include recommending, by the processor, the time wise-user sequence using a cosine similarity technique.

In an embodiment, the method may include generating, by the processor, the user data matrix by using at least one of: a content-based filtering technique and a collaborative filtering technique.

In an aspect, a user equipment (UE) for receiving personalized recommendations may include one or more processors communicatively coupled to a processor associated with a system. The one or more processors may be coupled with a memory. The memory may store instructions to be executed by the one or more processors that may cause the one or more processors to transmit a user parameter to the processor via a network. The processor may be configured to receive the user parameter from the UE. The user parameter may be based on a user watch history and a user interaction data with a time sequence. The processor may generate a user data matrix with the time sequence based on the user watch history and the user interaction data. The processor may index the generated user data matrix and rank, via a primary technique, the user data matrix based on the user watch history and the user interaction data. The processor may predict, via an AI engine, a time-wise user preference in an offline mode. The user preference may be based on the ranking of the user data matrix and a new content suggestion. The processor may generate an optimized model based on the time-wise user preference. The processor may recommend a time-wise user sequence in an online mode based on the generated optimized model and a subscribed user activity.

In an aspect, a non-transitory computer readable medium may include a processor with executable instructions that may cause the processor to receive a user parameter from one or more users via a computing device. The user parameter may be based on a user watch history and a user interaction data with a time sequence. The processor may generate a user data matrix with the time sequence based on the user watch history and the user interaction data. The processor may index the generated user data matrix and rank, via a primary technique, the user data matrix based on the user watch history and the user interaction data. The processor may predict, via an AI engine, a time-wise user preference in an offline mode based on the ranking of the user data matrix and a new content suggestion. The processor may generate an optimized model based on the time-wise user preference. The processor may recommend a time-wise user sequence in an online mode based on the generated optimized model and a subscribed user activity.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a proposed system (108), in accordance with an embodiment of the present disclosure.

FIG. 2 illustrates an exemplary block diagram (200) of a proposed system (108), in accordance with an embodiment of the present disclosure.

FIG. 3 illustrates an exemplary Bayesian Personalized Ranking (BPR) (300) for the system (108), in accordance with an embodiment of the present disclosure.

FIG. 4 illustrates exemplary loss functions (400) for the BPR, in accordance with an embodiment of the present disclosure.

FIG. 5 illustrates an exemplary flow diagram of an offline training (500) implemented by the system (108), in accordance with an embodiment of the present disclosure.

FIG. 6 illustrates exemplary online recommendations (600) provided by the system (108), in accordance with an embodiment of the present disclosure.

FIG. 7 illustrates an exemplary flow diagram (700) of a ranking system, in accordance with an embodiment of the present disclosure.

FIG. 8 illustrates an exemplary system architecture (800) of the system (108), in accordance with an embodiment of the present disclosure.

FIG. 9 illustrates an exemplary computer system (900) in which or with which the embodiments of the present disclosure may be implemented.

The foregoing shall be more apparent from the following more detailed description of the disclosure.

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

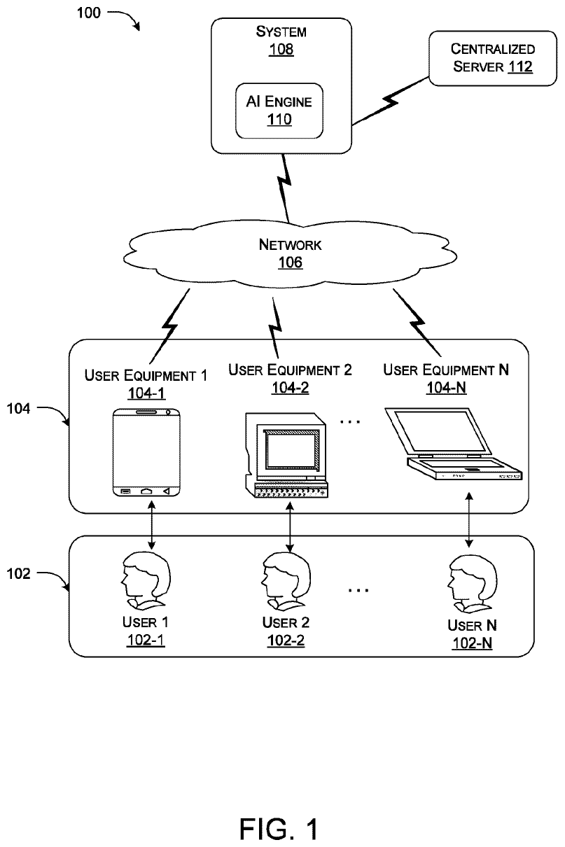

The various embodiments throughout the disclosure will be explained in more detail with reference to FIGS. 1-9.

FIG. 1 illustrates an exemplary network architecture (100) of a proposed system (110), in accordance with an embodiment of the present disclosure.

As illustrated in FIG. 1, the network architecture (100) may include a system (108). The system (108) may be connected to one or more computing devices (104-1, 104-2 . . . 104-N) via a network (106). Further, the system (108) may be connected to a centralized server (112) for processing various inputs provided to the system (108). The one or more computing devices (104-1, 104-2 . . . 104-N) may be interchangeably specified as a user equipment (UE) (104) and be operated by one or more users (102-1, 102-2 . . . 102-N). Further, the one or more users (102-1, 102-2 . . . 102-N) may be interchangeably referred as a user (102) or users (102). The system (108) may include an artificial intelligence (AI) engine (110) for generating an optimized model based on an input parameter provided by the users (102).

In an embodiment, the computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from the user (102) such as a touch pad, touch-enabled screen, electronic pen, and the like may be used. A person of ordinary skill in the art will appreciate that the computing devices (104) may not be restricted to the mentioned devices and various other devices may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive the input/user parameter from the one or more users (102). The user parameter may be based on a user watch history and a user interaction data with a time sequence. The system (108) may generate a user data matrix with the time sequence. The system (108) may use a content-based filtering technique to generate the user data matrix for an offline mode. The user data matrix may be based on the user watch history and the user interaction data. Further, the system (108) may index the generated user data matrix and rank, via a primary technique, the user data matrix based on the user watch history and the user interaction data. In an embodiment, the system (108) may use a Bayesian personalized ranking (BPR) technique as the primary technique.

In an embodiment, the system (108) may use an approximate nearest neighbors oh yeah (Annoy) technique to index the generated user data matrix.

In an embodiment, the system (108) may predict, via the AI engine (110), a time-wise user preference in the offline mode. The system (108) may use a long short-term memory (LSTM) technique to predict the time-wise user preference and generate an optimized model. Further, the system (108) may use at least one of content-based filtering technique and a collaborative filtering technique to generate the user data matrix. The user preference may be based on the ranking of the user data matrix and a new content suggestion. The new content suggestion may be based on, but not limited to, an age group, a region, and a country associated with the one or more users (102).

In an embodiment, the system (108) may generate the optimized model based on the time-wise user preference. The system (108) may recommend a time-wise user sequence in an online mode based on the generated optimized model and a subscribed user activity. The system (108) may use a cosine similarity technique to recommend the time-wise user sequence in the online mode. The subscribed user activity may include one or more user session data in the online mode.

In an embodiment, the system (108) may be interchangeably specified as a recommender system. The recommender system (108) may be a subclass of information filtering that seeks to predict the rating or preference provided by the users (102). For example, the users (102) may provide items that include, but not limited to, a product, a movie, and a song. The recommender system (108) may provide personalized information by learning the interests of the users (102) through one or more user interactions. Much like machine learning algorithms, the recommender system (108) may generate a prediction based on a past behaviour of the user (102). Specifically, the recommender system (108) may predict user preference for a set of items based on experience.

In an embodiment, the system (108) may use the content-based filtering technique that records a time-wise user preference based on the activity of the user (102). Content-based filtering may generate recommendations by using keywords and attributes assigned to objects in a database (e.g., items in an online marketplace) and matching them to a user profile. The user profile may be created based on data derived from a user's actions such as, but not limited to, purchases, ratings (likes and dislikes), downloads, items searched for on a website and/or placed in a cart, and clicks on product links.

In an embodiment, the user session data may include, but not limited to, various attributes/tags like objects detected, celebrities in movie, place and setup of content, genre of content (sports, music, politics, etc.). Further, the user session data may include audio and visual media utilized by the users (102) in the online mode and the offline mode while using streaming platforms.

In an embodiment, the system (108) may use a collaborative filtering technique that filters information by using user interactions and data collected from the users (102). The collaborative filtering technique may be based on the idea that users (102) who agreed in their evaluation of certain items and are likely to agree again in the future. The collaborative filtering technique may also be termed as a similarity index-based technique. In the neighbourhood-based approach, a number of users (102) may be selected based on their similarity to an active user. Inference for the active user may be made by calculating a weighted average of the ratings of the selected users (102). The collaborative-filtering technique may focus on the relationship between users (102) and items and the similarity of items may be determined by the similarity of the ratings of the items provided by the users (102).

In an embodiment, the system (108) may use an approximate nearest neighbors oh yeah (Annoy) technique to search for points in space that are close to a given query point. The Annoy technique may generate large read-only file-based data structures that are mapped into a memory of the system (108) so that many processes may share the same data. The Annoy technique may use random projections and building up a tree. At every intermediate node in the tree, a random hyperplane may be chosen which divides the space into two subspaces. Further, the hyperplane may be chosen by sampling two points from the subset and taking the hyperplane equidistant from the two points. By iterating this process k times, one or more forest of trees may be generated, where “k” may be based on trade-off between precision and performance.

In an embodiment, the system (108) may generate a sparse implicit interaction dataset based on the user interaction data and the user watch history. The system (108) may generate the optimized model by being configured to generate a sparse implicit interaction dataset based on the user interaction data and the user watch history. Further, the system (108) may generate, via the primary technique, an initial distribution of data based on the sparse implicit interaction dataset. The system (108) may index the initial distribution of data to generate one or more indices and scale the one or more indices. The system (108) may reiterate the primary technique on the scaled one or more indices and generate the optimized model.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

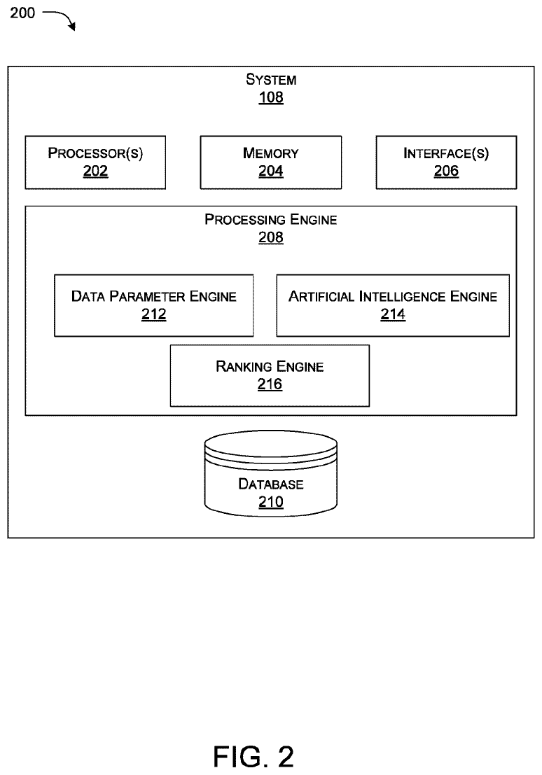

FIG. 2 illustrates an exemplary block diagram (200) of a proposed system (108), in accordance with an embodiment of the present disclosure.

Referring to FIG. 2, the system (108) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (108). Examples of such components include, but are not limited to, processing engine(s) (208) and a database (210), where the processing engine(s) (208) may include, but not be limited to, a data parameter engine (212), an AI engine (214), and a ranking engine (216). A person with ordinary skill in the art may understand that the AI engine (214) may be similar to the AI engine (110) of FIG. 1 in its functionality.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the processor (202) may receive a user parameter via the data parameter engine (212) from one or more users (102). The one or more users (102) may operate via a computing device (104) and may be connected to the processor (202) via a network (106). The processor (202) may store the user parameter in the database (210). The user parameter may be based on a user watch history and a user interaction data received by the processor (202) with a time sequence. The processor (202) may generate a user data matrix with the time sequence. The processor (202) may use a content-based filtering technique to generate the user data matrix for the offline mode. The user data matrix may be based on the user watch history and the user interaction data.

Further, in an embodiment, the processor (202) may index the generated user data matrix and rank, via a primary technique, the user data matrix based on the user watch history and the user interaction data. The processor (202) may use the ranking engine (216) to rank the data matrix using the primary technique. In an embodiment, the processor (202) may use a BPR technique as the primary technique. The processor (202) may use the Annoy technique to index the generated user data matrix.

In an embodiment, the processor (202) may predict, via the AI engine (214), a time-wise user preference in an offline mode. The processor (202) may use an LSTM technique to predict the time-wise user preference and generate an optimized model. Further, the processor (202) may use a collaborative filtering technique to generate the user data matrix for the offline mode. The user preference may be based on the ranking of the user data matrix and a new content suggestion. The new content suggestion may be based on at least one of an age group, a region, and a country associated with the one or more users (102).

In an embodiment, the processor (202) may generate the optimized model based on the time-wise user preference. The processor (202) may recommend a time-wise user sequence in an online mode based on the generated optimized model and a subscribed user activity. The processor (202) may use a cosine similarity technique to recommend the time wise user sequence in the online mode. The subscribed user activity may include one or more user session data in the online mode.

In an embodiment, the processor (202) may generate a sparse implicit interaction dataset based on the user interaction data and the user watch history. The processor (202) may generate a sparse implicit interaction dataset based on the user interaction data and the user watch history. Further, the processor (202) may generate, via the primary technique, an initial distribution of data based on the sparse implicit interaction dataset. The processor (202) may index the initial distribution of data to generate one or more indices and scale the one or more indices. The processor (202) may reiterate the primary technique on the scaled one or more indices and generate the optimized model.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

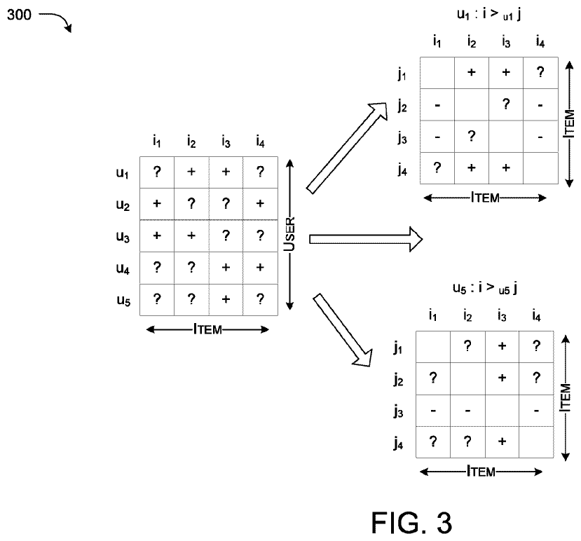

FIG. 3 illustrates an exemplary BPR (300) for the system (108), in accordance with an embodiment of the present disclosure.

As illustrated in FIG. 3, the BPR may include a matrix U based on the preferences of a useru. If the user clicks the itemi, but does not click the itemj, U[i][j] may be positive, and U[j][i] may be negative. If the user clicks both or neither of them, then no value may be assigned to both U[i][j] and U[j][i]. The BPR technique may rank user preferences based on user watch history and user interaction data. In an embodiment, the BPR technique may include an optimization criterion BPR-optimization (BPR-OPT) and an algorithm Learn BPR for the optimization. The BPR technique may predict the relative user preferences for all pairs (i, j). The BPR technique may maximize the number of correct predictions of all pairs (i, j), which may be equivalent to maximizing the area under a receiving operating characteristic curve (ROC) (AUC) curve. The AUC may include a Heaviside function, which is not differentiable.

δ(x>0):={1,x>0 0,else

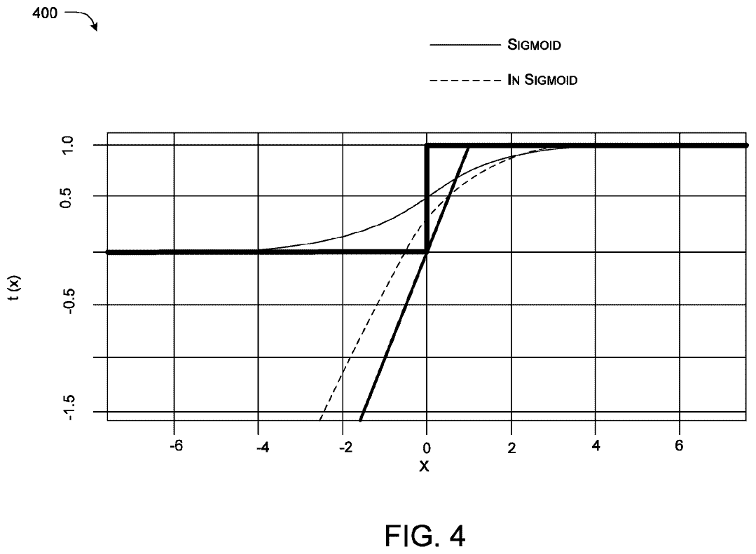

FIG. 4 illustrates exemplary loss functions (400) for the BPR, in accordance with an embodiment of the present disclosure.

As illustrated in FIG. 4, the BPR-OPT may use a logistic sigmoid function to replace the Heaviside function, hence a gradient descent may be used for optimization. The BPR-OPT may use the sigmoid to replace Heaviside function as shown below.

$$\begin{matrix}p ( i {>}_{u} j \vert Θ ) := σ ( {\hat{x}}_{uij} ( Θ ) ) \\ σ ( x ) := \frac{1}{1 + {e}^{- x}}\end{matrix}$$

In an embodiment, the Heaviside function may represent the probability based on a preference of the users (102). Further, the algorithm Learn BPR may find the model's parameters, Θ, to maximize the BPR-OPT.

$$p ( Θ \text{\textbar >} u ) ∝ p ( > u \vert Θ ) p ( Θ )$$

Furthermore, the user-specific likelihood function p (>u|Θ) may first be rewritten as the equation above with an assumption that all users (102) act independently with each other. Further, the above equation may be based on an assumption that an ordering of each pair of items (i, j) for a specific user (102) may be independent.

Hence, the probability of all user preferences may be written as the following equation.

$${\prod }_{u ∈ U} p ( > u \vert Θ ) = {\prod }_{( u , i , j ) ∈ {D}_{s}} p ( i {>}_{u} j \vert Θ )$$

Since the log function is a strictly increasing function, the BPR-OPT may be defined as:

$$\begin{matrix}BPR - {O}_{PT} := ln p ( Θ \vert {>}_{u} ) \\ = p ( > u \vert Θ ) p ( Θ ) \\ = {\sum }_{uij} ln σ ( {\hat{x}}_{uij} ) + ln p ( Θ ) \\ = {\sum }_{uij} ln σ ( {\hat{x}}_{uij} ) + {λ}_{Θ} {‖ Θ ‖}^{2}\end{matrix}$$

The BPR-OPT may be differential and the gradient of the BPR-OPT may be calculated.

$$\begin{matrix}\frac{\partial BPR - {O}_{PT}}{\partial Θ} := {\sum }_{( u , i , j ) ∈ {D}_{s}} \frac{\partial }{\partial Θ} ln σ ( {\hat{x}}_{uij} ) + {λ}_{Θ} {‖ Θ ‖}^{2} \\ ∝ {\sum }_{( u , i , j ) ∈ {D}_{s}} \frac{- {e}^{{\hat{x}}_{uij}}}{1 + - {e}^{{\hat{x}}_{uij}}} \cdot \frac{\partial }{\partial Θ} {\hat{x}}_{uij} - {λ}_{Θ} Θ\end{matrix}$$

Training dataset Dₛ which contains all pair (useru, itemi, itemj) from the matrix u, where the user prefers itemi to itemj may be calculated. The following algorithm may be used for bootstrapping.

$$\begin{matrix}initialize Θ \\ repeat \\ draw ( u , i , j ) from {D}_{s} \\ Θ ← Θ + α ( \frac{- {e}^{{\hat{x}}_{uij}}}{1 + - {e}^{{\hat{x}}_{uij}}} \cdot \frac{\partial }{\partial Θ} {\hat{x}}_{uij} - {λ}_{Θ} \cdot Θ ) \\ until convergence\end{matrix}$$

The algorithm Learn BPR may allow the use of a gradient descent to optimize the non-differential AUC. Further, the algorithm Learn BPR may be combined with different models to get better ranking results.

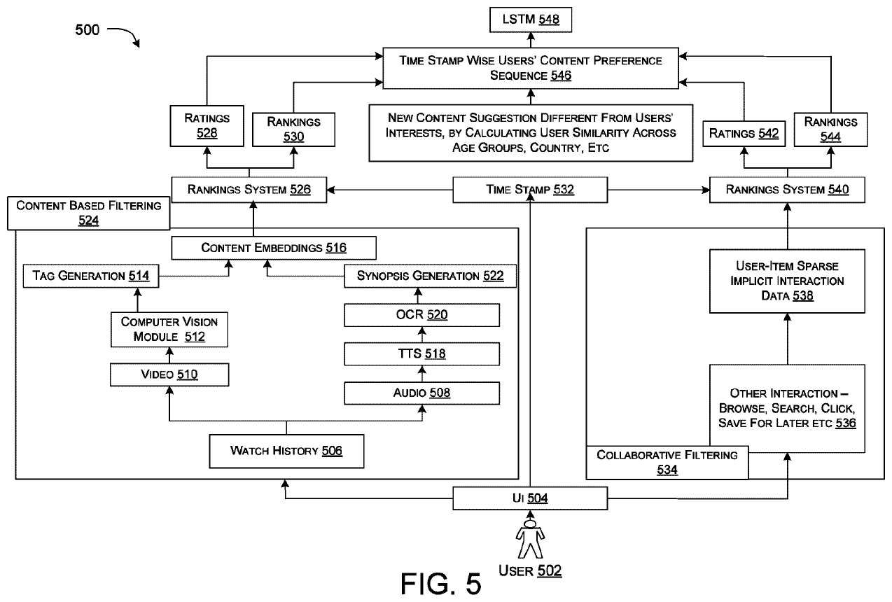

FIG. 5 illustrates an exemplary flow diagram of an offline training (500) implemented by the system (108), in accordance with an embodiment of the present disclosure.

As illustrated in FIG. 5, a user (502) may provide a watch history (506) via a user interface (504). The watch history (506) may include audio files (508) and video files (510). A computer vision module (512) may provide tag generation (514) to the video files (510) and send the video files (510) to a content embeddings module (516) for processing. Similarly, a text to speech (TTS) conversion module (518) may process the audio files (508) using an optical character recognition (OCR) module (520), and the processed audio files (508) may be sent to a synopsis generation module (522). The synopsis generation module (522) may further send the processed audio files (508) to the content embeddings module (516) for processing. Hence, an output generated by a content-based filtering process (524) may be provided to a rankings system (526) that may generate time-wise ratings (528) and rankings (530) with the help of a time stamp module (532). Hence, the output from the content-based filtering process (524) may be used to generate a time stamp wise user content preference sequence (546).

Similarly, for other interactions (536) including, but not limited to, browse, search, click, save for later, etc., user-item sparse implicit interactions data (538) may be prepared in form of a matrix. Hence, an output form a collaborative filtering process (534) may be provided to a rankings system (540) that may generate time-wise ratings (542) and rankings (544) with the help of the time stamp module (532). Further, the output from the collaborative filtering process (534) may be used to generate the time stamp wise users content preference sequence (546).

Hence, outputs from the content-based filtering process (524) and the collaborative filtering process (534) may be used by an LSTM module (548) to generate an optimized model for the offline training (500).

In an embodiment, the following steps may be used by the system (108) during offline training (500). For example, all user activities may be logged into a user database. The watched content (506) may be demultiplexed into video files (510) and audio files (508). The video files (510) may be processed using the computer vision module (512) to generate relevant tags. These processes may include, object detection, human activity detection, celebrity detection, and genre detection, among many others. Further, the audio files (508) may be similarly processed to generate synopsis for the content, and sentiment analysis may be performed to predict temporal sentiment across the whole duration.

In an embodiment, the generated tags may be embedded and passed to Annoy for indexing. Annoy may index by picking two points randomly and then splitting by the hyperplane equidistant from those two points. Hence, Annoy may consequently build a data structure that may include nearest points to any query point in a sublinear time.

Further, the indices may be scaled using temporal information. The BPR technique may be reiterated on the scaled indices, to get optimized hyperplanes, or splits.

In an embodiment, the following time decay function may be used on the hyperplanes.

$$\begin{matrix}w ( i , t ) = \frac{f ( t - {t}_{i} )}{f ( t - t )} = \frac{f ( t - {t}_{i} )}{f ( 0 )} \\ where \\ f ( a ) = exp ( - α ln ( a + 1 ) )\end{matrix}$$

For all other interactions (536), the user-item sparse implicit interaction dataset (538) may be created. The user-item sparse interaction dataset (538) may be then fed to the BPR technique or the rankings system (540) to get initial distribution in the high dimensional space. In an embodiment, the generated distribution may be indexed using Annoy.

As explained herein, the indices may be scaled using the time stamp of their occurrence. Following time decay function may be used to scale the indices.

$$\begin{matrix}w ( i , t ) = \frac{f ( t - {t}_{i} )}{f ( t - t )} = \frac{f ( t - {t}_{i} )}{f ( 0 )} \\ where \\ f ( a ) = exp ( - α ln ( a + 1 ) )\end{matrix}$$

In an embodiment, the BPR technique may be reiterated on these scaled indices, to get optimized hyperplanes, or splits.

Since these scaled indices have inherent character of having a sense of similarity to other indices and also contain temporal information, the LSTM back propagation may easily converge to an optimal solution. In an embodiment, some content based on user similarity, i.e., age group, region, country, etc., may also be taken into consideration.

Hence, the generated information may be then arranged in a time stamp wise sequence of preferences for each user. This data may then be fed to LSTM module (548) to obtain a prediction for next sequence of preferences.

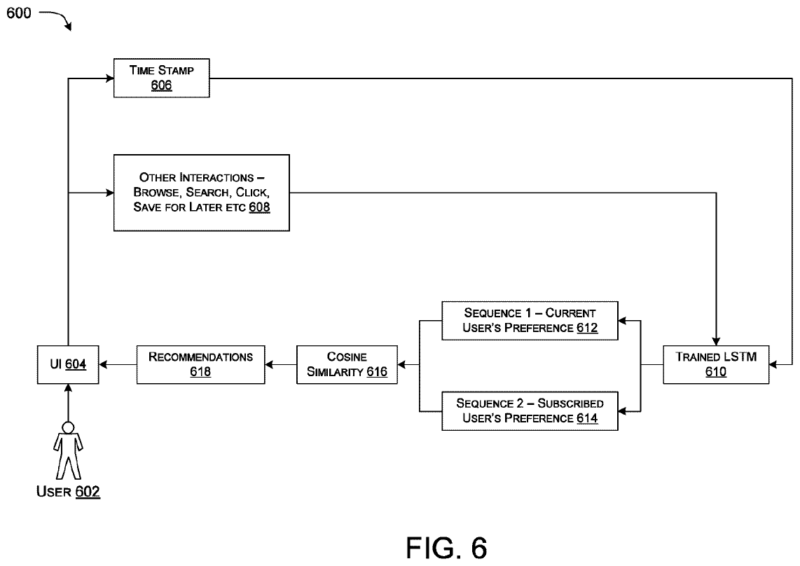

FIG. 6 illustrates exemplary online recommendations (600) provided by the system (108), in accordance with an embodiment of the present disclosure.

As illustrated in FIG. 6, the followings steps may be used for generating the online recommendations (600).

For example, a time stamp wise user's preference sequence may be generated for a current session. The time stamp wise user's preference sequence may include a time stamp (606) and other interactions (608). The other interactions (608) may include, but not limited to, browse, search, click, and save for later. The time stamp wise user's preference sequence may be provided to a trained LSTM module (610). The predicted sequence, S1 (612) may represent current user's preference, which may or may not aligned with the subscribed user's activity.

Further, another prediction may be made in absence of this session's data to get another sequence, S2 (614). S2 (614) may represent subscribed user's preferences.

Referring to FIG. 6, a cosine similarity technique (616) may be performed between the two sets of preferences (S1 and S2), giving higher weights to S1 (612).

The sorted preference sequence may include recommendations (618) based on the trained LSTM module (610). The sorted preference sequence (618) may be provided to a user (602) via a user interface (604).

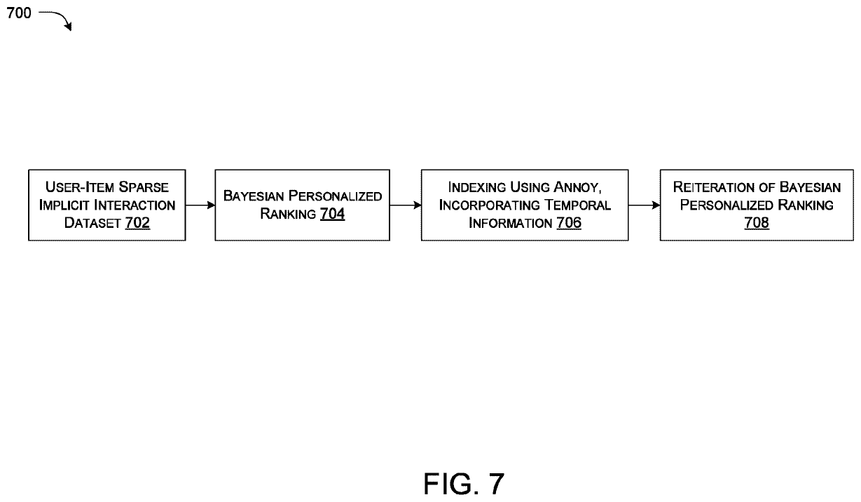

FIG. 7 illustrates an exemplary flow diagram (700) of a ranking system, in accordance with an embodiment of the present disclosure.

As illustrated in FIG. 7, the flow diagram (700) may include the following steps. For example, a user item sparse implicit interaction dataset (702) may be created. The user item sparse implicit interaction dataset (702) may be then fed to a BPR system (704) to generate an initial distribution in a high dimensional space. The initial distribution may be indexed using Annoy (706). Annoy (706) may pick two points randomly and split the two points using a hyperplane equidistant from the two points. Further, Annoy (706) may consequently build a data structure that helps in finding the nearest points to any query point in a sublinear time.

In an embodiment, the indices generated by the BPR system (704) may be scaled using a time stamp of their occurrence. A time decay function may be used to scale the indices:

$$\begin{matrix}w ( i , t ) = \frac{f ( t - {t}_{i} )}{f ( t - t )} = \frac{f ( t - {t}_{i} )}{f ( 0 )} \\ where \\ f ( a ) = exp ( - α ln ( a + 1 ) )\end{matrix}$$

The BPR technique may be reiterated (708) on the scaled indices, to get optimized hyperplanes, or splits. The scaled indices may have inherent character of having a sense of similarity to other indices and may also contain temporal information. Hence, a LSTM back propagation may easily converge to an optimal solution.

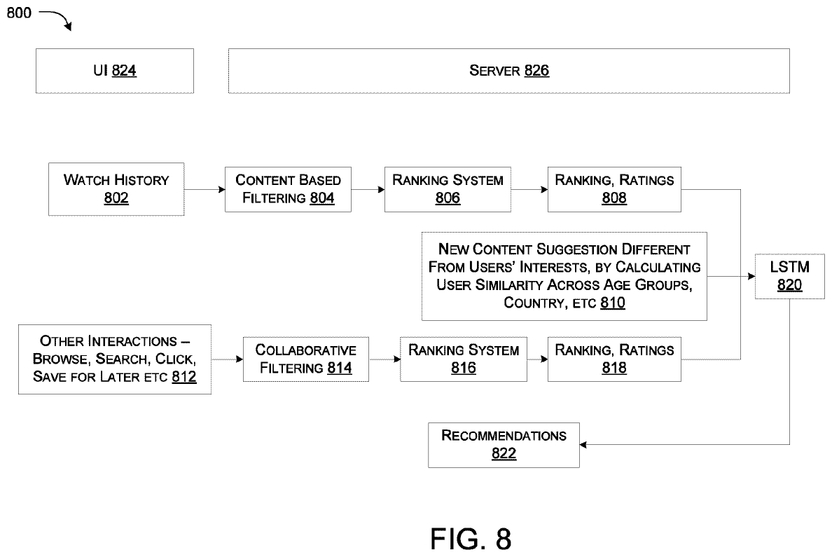

FIG. 8 illustrates an exemplary system architecture (800) of the system (108), in accordance with an embodiment of the present disclosure.

As illustrated in FIG. 8, a user watch history (802) may be provided to a content-based filtering module (804). The content-based filtering module (804) may generate an output based on the user watch history (802). The output may be ranked using a ranking system (806). Further, rankings and ratings (808) may be provided to a LSTM module (820) for further processing. Similarly, a collaborative filtering module (814) may use other interactions (812) from users (102) and generate an output. The output from the collaborative filtering module (814) may be ranked using a ranking system (816). Further, the ranked output may be provided with rankings and ratings (818) to the LSTM module (820) for processing. The LSTM module (820) may generate an optimized output that may include providing ranked recommendations (822) to the users (102). The ranked recommendations (822) generated at the server (826) may be accessed via a user interface (824) by the users (102). It may be appreciated that the server (826) may be implemented as the system (108) or may be implemented within the system (108).

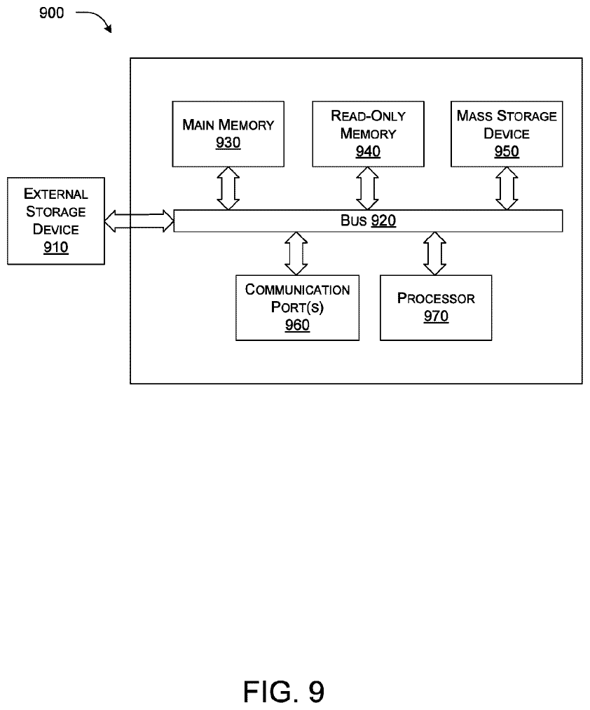

FIG. 9 illustrates an exemplary computer system (900) in which or with which embodiments of the present disclosure may be implemented.

As shown in FIG. 9, the computer system (900) may include an external storage device (910), a bus (920), a main memory (930), a read-only memory (940), a mass storage device (950), a communication port(s) (960), and a processor (970). A person skilled in the art will appreciate that the computer system (900) may include more than one processor and communication ports. The processor (970) may include various modules associated with embodiments of the present disclosure. The communication port(s) (960) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (960) may be chosen depending on a network, such as a Local Area Network (LAN), Wide Area Network (WAN), or any network to which the computer system (900) connects.

In an embodiment, the main memory (930) may be Random Access Memory (RAM), or any other dynamic storage device commonly known in the art. The read-only memory (940) may be any static storage device(s) e.g., but not limited to, a Programmable Read Only Memory (PROM) chip for storing static information e.g., start-up or basic input/output system (BIOS) instructions for the processor (970). The mass storage device (950) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (920) may communicatively couple the processor(s) (970) with the other memory, storage, and communication blocks. The bus (920) may be, e.g. a Peripheral Component Interconnect PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (970) to the computer system (900).

In another embodiment, operator and administrative interfaces, e.g., a display, keyboard, and cursor control device may also be coupled to the bus (920) to support direct operator interaction with the computer system (900). Other operator and administrative interfaces can be provided through network connections connected through the communication port(s) (960). Components described above are meant only to exemplify various possibilities. In no way should the aforementioned exemplary computer system (900) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that indexes user item interactions prior to a Bayesian Personalized Ranking, thereby reducing time complexity and speeding up training time.

The present disclosure provides a system and a method that incorporates temporal information while calculating the Bayesian Personalized Ranking, and thereby, improving relative ranking of recommendations.

The present disclosure provides a system and a method that uses indices generated from the Bayesian Personalized Ranking, instead of user-items as inputs to long short-term memory (LSTM) optimization model, thereby providing better convergence to an optimization function.

The present disclosure provides a system and a method that recommends personalized content to users while ensuring viewer experience and retention.

The present disclosure provides a system and a method that uses a cosine similarity technique between an inference output of the trained optimization model and a user interaction, thereby generating significant results compared to conventional systems.

We claim:

1. A system (108) for generating personalized recommendations based on user preferences, the system (108) comprising:
a processor (202); and
a memory (204) operatively coupled with the processor (202), wherein said memory (204) stores instructions, which when executed by the processor (202), cause the processor (202) to:
receive a user parameter from one or more users (102) via a computing device (104), wherein the one or more users (102) operate the computing device (104) and are connected to the processor (202) via a network (106), and wherein the user parameter is based on a user watch history and a user interaction data with a time sequence;
generate a user data matrix with the time sequence based on the user watch history and the user interaction data;
index the generated user data matrix and rank, via a primary technique, the user data matrix based on the user watch history and the user interaction data;
predict, via an artificial intelligence (AI) engine (110), a time-wise user preference in an offline mode based on the ranking of the user data matrix and a new content suggestion;
generate an optimized model based on the time-wise user preference; and
recommend a time-wise user sequence in an online mode based on the generated optimized model and a subscribed user activity.

2. The system (108) as claimed in claim 1, wherein the processor (202) is to index the generated user data matrix using an approximate nearest neighbors oh yeah (Annoy) technique.

3. The system (108) as claimed in claim 1, wherein the primary technique comprises a Bayesian Personalized Ranking (BPR) technique.

4. The system (108) as claimed in claim 1, wherein the new content suggestion is based on at least one of: an age group, a region, and a country associated with the one or more users (102).

5. The system (108) as claimed in claim 1, wherein the processor (202) is to predict the time-wise user preference and generate the optimized model using a long short-term memory (LSTM) technique.

6. The system (108) as claimed in claim 1, wherein the processor (202) is to recommend the time-wise user sequence using a cosine similarity technique.

7. The system (108) as claimed in claim 1, wherein the subscribed user activity comprises one or more user session data in the online mode.

8. The system (108) as claimed in claim 1, wherein the processor (202) is to generate the optimized model by being configured to:
generate a sparse implicit interaction dataset based on the user interaction data and the user watch history;
generate, via the primary technique, an initial distribution of data based on the sparse implicit interaction dataset;
index the initial distribution of data to generate one or more indices and scale the one or more indices; and
reiterate the primary technique on the scaled one or more indices and generate the optimized model.

9. The system (108) as claimed in claim 8, wherein the scaled one or more indices comprise temporal information associated with the user watch history, the user interaction data, and the subscribed user activity.

10. The system (108) as claimed in claim 1, wherein the processor (202) is to generate the user data matrix using at least one of: a content-based filtering technique and a collaborative filtering technique.

11. A method for generating personalized recommendations based on user preferences, the method comprising:
receiving, by a processor (202) associated with a system (108), a user parameter from one or more users (102), wherein the user parameter is based on a user watch history and a user interaction data with a time sequence;
generating, by the processor (202), a user data matrix with the time sequence based on the user watch history and the user interaction data;
indexing, by the processor (202), the generated user data matrix and ranking, via a primary technique, the user data matrix based on the user watch history and the user interaction data;
predicting, by the processor (202), via an artificial intelligence (AI) engine (110), a time-wise user preference in an offline mode based on the ranking of the user data matrix and a new content suggestion;
generating, by the processor (202), an optimized model based on the time-wise user preference; and
recommending, by the processor (202), a time-wise user sequence in an online mode based on the generated optimized model and a subscribed user activity.

12. The method as claimed in claim 11, comprising indexing, by the processor (202), the generated user data matrix using an approximate nearest neighbors oh yeah (Annoy) technique.

13. The method as claimed in claim 11, wherein the primary technique comprises a Bayesian Personalized Ranking (BPR) technique.

14. The method as claimed in claim 11, comprising predicting, by the processor (202), the time-wise user preference and generating the optimized model using a long short-term memory (LSTM) technique.

15. The method as claimed in claim 11, comprising recommending, by the processor (202), the time-wise user sequence using a cosine similarity technique.

16. The method as claimed in claim 11, comprising generating, by the processor (202), the user data matrix using at least one of: a content-based filtering technique and a collaborative filtering technique.

17. A user equipment (UE) (104) for receiving personalized recommendations, the UE (104) comprising:
one or more processors communicatively coupled to a processor (202) associated with a system (108), wherein the one or more processors are coupled with a memory, and wherein said memory stores instructions, which when executed by the one or more processors, cause the one or more processors to:
transmit a user parameter to the processor (202) via a network (106), wherein the processor (202) is configured to:
receive the user parameter from the UE (104), wherein the user parameter is based on a user watch history and a user interaction data with a time sequence;
generate a user data matrix with the time sequence based on the user watch history and the user interaction data;
index the generated user data matrix and rank, via a primary technique, the user data matrix based on the user watch history and the user interaction data;
predict, via an artificial intelligence (AI) engine (110), a time-wise user preference in an offline mode based on the ranking of the user data matrix and a new content suggestion;
generate an optimized model based on the time-wise user preference; and
recommend a time-wise user sequence in an online mode based on the generated optimized model and a subscribed user activity.

18. A non-transitory computer readable medium comprising a processor with executable instructions, causing the processor to:
receive a user parameter from one or more users (102) via a computing device (104), wherein the user parameter is based on a user watch history and a user interaction data with a time sequence;
generate a user data matrix with the time sequence based on the user watch history and the user interaction data;
index the generated user data matrix and rank, via a primary technique, the user data matrix based on the user watch history and the user interaction data;
predict, via an artificial intelligence (AI) engine (110), a time-wise user preference in an offline mode based on the ranking of the user data matrix and a new content suggestion;
generate an optimized model based on the time-wise user preference; and
recommend a time-wise user sequence in an online mode based on the generated optimized model and a subscribed user activity.
